(19) United States
(12) Patent Application Publication
(10) Pub. No.: US 2011/0291916 A1
(43) Pub. Date: Dec. 1, 2011

(54) METHOD FOR TRANSMITTING AN IMAGE FROM A FIRST CONTROL UNIT TO A SECOND CONTROL UNIT AND OUTPUT UNIT

(76) Inventors: Frank Arndt, Berlin (DE); Hans-Gerd Brummel, Berlin (DE); Volker Heblinski, Glienicke (DE); Willi Paschmann, Berlin (DE); Christian Reimann, Salzkotten (DE); Holger Santelmann, Paderborn-Elsen (DE); Olaf Schmidt, Vogelsdorf (DE); Gerhard Schulz, Rietberg (DE); Dietmar Weber, Berlin (DE)

(21) Appl. No.: 13/133,732

(22) PCT Filed: Sep. 15, 2009
(86) PCT No.: PCT/EP2009/061959

§ 371 Date: Aug. 23, 2011

(30) Foreign Application Priority Data
Dec. 10, 2008 (DE) 10 2008 061 448.3

(51) Int. Cl. G09G 5/00

(52) U.S. Cl. 345/2.2

(57) ABSTRACT

A method for transmitting an image from a first control unit to a second control unit is provided wherein a maintenance technician can view the same image on a head-mounted display from the first output unit as an expert in the back office. The image is played back on the first output unit with the same resolution as on the head-mounted display.

### CROSS REFERENCE TO RELATED APPLICATIONS

This application is the US National Stage of International Application No. PCT/EP2009/061959, filed Sep. 15, 2009 and claims the benefit thereof. The International Application claims the benefits of German application No. 10 2008 061 448.3 DE filed Dec. 10, 2008. All of the applications are incorporated by reference herein in their entirety.

### FIELD OF INVENTION

The invention relates to a method for transmitting an image from a first control unit to a second control unit, and an output unit for carrying out the method.

### BACKGROUND OF INVENTION

Wikipedia “Head-Mounted Display” (printed March 2009) discloses various embodiments of a head-mounted visual output appliance which shows images produced on the computer on a screen close to the eye or projects them directly onto the retina.

For the purpose of maintaining technical installations, the maintenance engineer has a mobile computer system having a head-mounted display HMD. The maintenance engineer can access application-related documents on his mobile computer system, the documents being fortified from documents which are required for the purpose of maintaining the technical installation in question. These documents are usually prepared by an expert in the back office. The maintenance engineer can display the documents on his head-mounted display on the mobile computer system by being able to use a zoom function to select a suitable image section from an overall image.

The presentation capability of a head-mounted display differs significantly from the presentation capability of an ordinary monitor for the expert in the back office. In particular, the resolution of the HMD is significantly lower.

To date, the maintenance engineer has used a zoom function to select the important details from the documents, in a time-consuming manner.

### SUMMARY OF INVENTION

The object of the invention is to provide a method and an apparatus which the maintenance engineer can use to operate his computer system with an HMD using as few interactions as possible.

The object of the invention is achieved by the features of the independent patent claims.

Advantageous developments of the invention are presented in the dependent patent claims.

A method according to the invention is used in which the image to be presented is presented by a first control unit on a first output unit at a first image resolution. The second control unit having a second output unit is used to present the image that is to be presented on the second output unit at the same image resolution as on the first monitor, the second output unit being in the form of an HMD.

In this case, the first output unit is preferably in the form of a commercially available monitor, e.g. an LCD monitor having a high image resolution of 1280×800 or more, for example, and the first control unit is in the form of a commercially available computer.

Preferably, the second output unit holds, outside of the first image, further pixels for presenting status information and an input menu panel for sequentially calling the image or further images. In this case, the further image/the further images is/are, like the first image, presented on the second output unit at the same image resolution as on the first output unit.

This allows the maintenance engineer to access the desired information quickly. In addition, the maintenance engineer requires only a simple input means, e.g. with the simple function “click forward—click back”.

Preferably, the image is compiled from a photograph of the technical installation that is to be maintained and the respective annotations that are overlaid on the photograph, such as text containing technical circumstances, freehand lines, circles around technical circumstances presented in the photograph. As a result, the maintenance engineer quickly has all the relevant information available.

Preferably, the first output unit holds, outside of the image, further pixels for presenting an input menu panel for the purpose of storing the image that is to be transmitted. As a result, it is possible for the maintenance engineer to be provided with exactly or only the images which he actually needs.

Preferably, the first output unit additionally holds, outside of the images, further pixels for presenting a further input menu panel which allow a preview of a digital photograph from which a subsection from a first or further photograph can be selected by means of menu guidance. As a result, the expert in the back office can use this system to select precisely the image sections which the maintenance engineer requires. This prevents the maintenance engineer from being distracted by unimportant image sections.

Preferably, the maintenance engineer can use his control unit having the head-mounted display for online access to those images stored on the first control unit which the expert in the back office has stored for the maintenance engineer. As a result, the maintenance engineer always has the most up to date versions of the images available.

Preferably, the image desired by the maintenance engineer is transmitted to the second control unit, and stored thereon, by the first control unit via a data transmission line in advance. The maintenance engineer is therefore able to view the respectively called image locally from his second control unit by actuating a menu window on the HMD. As a result, the maintenance engineer can access his documents even without the available of an online dataline, e.g. if the data transmission line fails in the event of a fault.

Preferably, the first output unit has a higher vertical and/or horizontal image resolution than the second output unit. As a result, the expert in the back office can use his large monitor to create the images for the maintenance engineer conveniently and quickly.

Preferably, the maintenance engineer can access only the unalterable images which have been created by the expert in the back office. It is therefore not possible for the image to be customized by the maintenance engineer. This prevents the image from being altered by the maintenance engineer by mistake during use and being provided with a format which is difficult to read on the HMD.

In order to prevent the maintenance engineer from consciously customizing a document or an image, the interface which the expert in the back office uses to make the annotations is customized such that he automatically—and without having to consider it—provides the second control unit only with documents or sections having annotations which can also be viewed by the maintenance engineer using an HMD.

The interface element—developed for viewing the document or the image and for inserting annotations—on the first output unit has precisely the resolution or size (in pixels) of the interface element developed for the display in the HMD. This prevents otherwise necessary scaling operations, in which the document is sometimes visually impaired. From the general stock of documents, the expert in the back office selects documents and determines the required document section for each work step by the engineer, sometimes even a plurality of sections per document. The expert adds any annotations and stores them in a structured directory which is made available to the engineer online or offline.

### BRIEF DESCRIPTION OF THE DRAWINGS

The text below presents the figures for explaining the invention, in which:

FIG. 1: shows the system on which the method for transmitting an image from a first to a second control unit can be carried out.

FIG. 2: shows an illustration of an image on the first output unit, said image being able to be edited by the expert in the back office.

FIG. 3: shows the illustration of an image on an HMD, said image being able to be selected by a maintenance engineer using a menu.

FIG. 4: shows a comparison between the presentations on the first output unit and on the second output unit (HMD).

FIG. 4a: shows a further comparison between the presentations on the first output unit and on the second output unit (HMD).

### DETAILED DESCRIPTION OF INVENTION

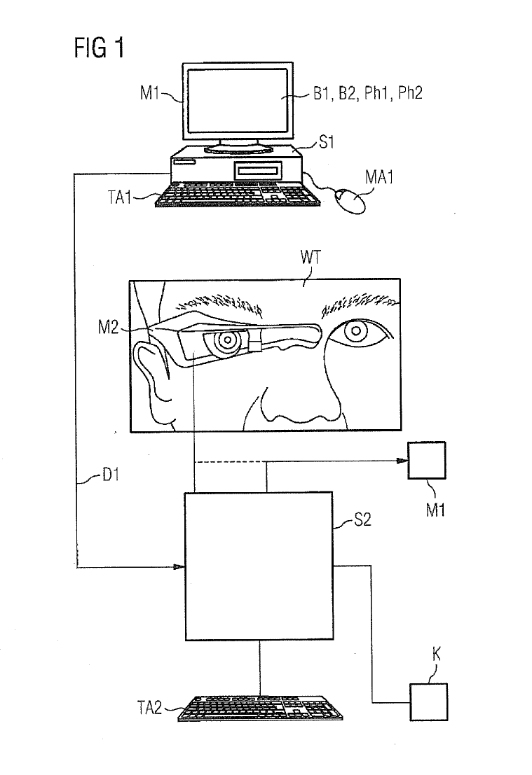

FIG. 1 shows the system on which the method for transmitting an image from a first to a second control unit S1, S2 is executed. FIG. 1 shows a first control unit S1, which is a commercially available computer. As an input medium, the control unit S1 has a keyboard TA1 and a mouse MA connected to it. The output unit M1 is in the form of a commercially available LCD monitor having a high image resolution of 1280×800 or more. The monitor M1 is used to output the images B1, B2, photographs PH1, PH2 and input panels EM11 to EM14 which are shown in the subsequent figures.

A second control unit S2 is provided, to which a keyboard TA2, a mouse MA2, a microphone MI and a second output unit M2 can be connected as input media. The second output unit M2 is in the form of a head-mounted display (HMD) which is worn on the head by a maintenance engineer WT and allows flexible mobile use even under difficult ambient conditions.

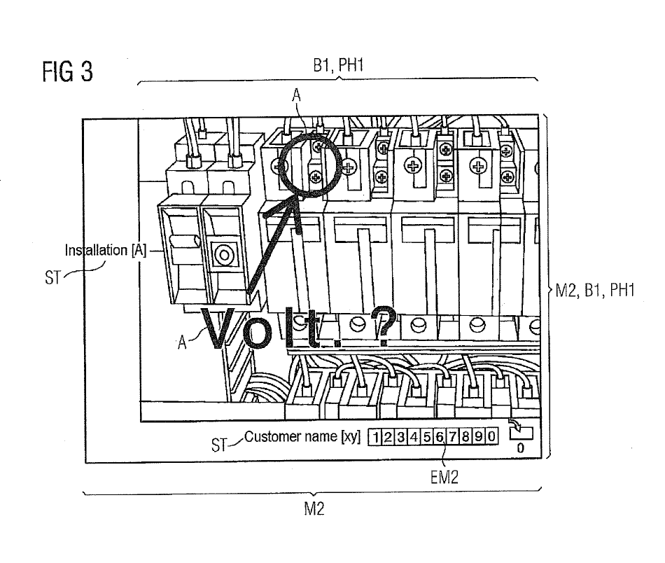

It is also possible for the second control unit S2 to have special input means connected to it which are designed for flexible use by the maintenance engineer WT. In particular, the simplified menu guidance shown in FIG. 3 below means that a simple input means K having the functionality “click image forward/click forward—click image backward/click back” is sufficient. (What input means are there on the market?).

In addition, the maintenance engineer can use voice control, for example using the command “forward”, the command “back”, via the microphone MI connected to the headset M2 or to the computer S2 in order to control the menu panel EM2 shown in FIG. 3.

The second output unit M2 is used to present the overall image shown in FIG. 3 below:

The first and second control units S1, S2 can be connected to one another via a data link D1. By way of example, the data link D1 can be set up using an ordinary TCP/IP Internet protocol. Alternatively, the data link D1 can be set up asynchronously by storing the data on a transportable data storage medium (hard disk, USB stick, etc.).

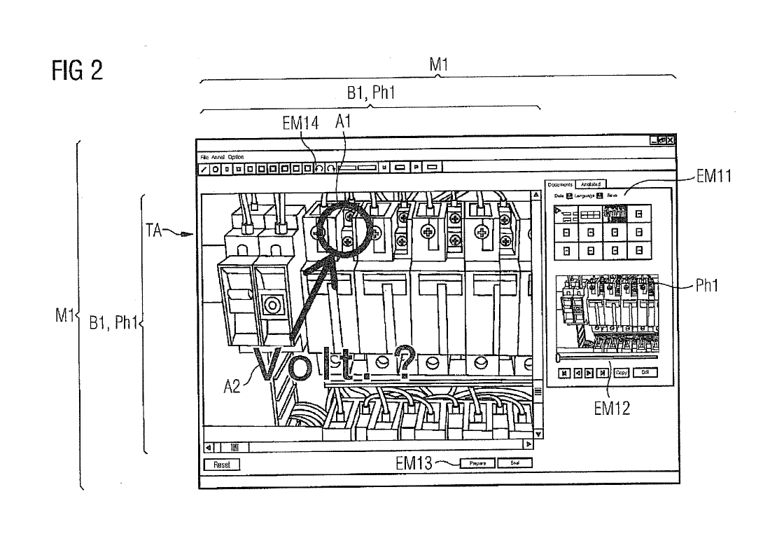

FIG. 2 shows the output on a first output unit M1, on which an image B1 is able to be edited by an expert in the back office. The image B1 shows a technical installation TA. The expert in the back office now edits the image B1 of the technical installation TA such that the maintenance engineer WT is pointed specifically toward the technical problem. This is done by selecting from a suitable subsection of a photograph PH1, which is visible to the right of the image B1 in a menu panel EM12.

The expert is able to overlay the image B1 with annotations using the menu panel EM14 arranged above the image B1. By way of example, in this case a circle A1 is placed around the special technical property “terminals” of a technical installation TA. An arrows links the text “Volt?” to the circle A1. The annotations A1, A2 point out to the maintenance engineer that he needs to consider or measure or check the voltage (in volts) across the terminals in the circle A1. In the image B1, the technical installation TA contains a few fuse switches including wiring in a switchgear cabinet. In addition, lines, rectangles and other geometric shapes can be overlaid on the image B1.

Outside of the image B1, there are further screen areas included with different menu panels EM11 to EM14:

Arranged to the right of the image B1 is the menu panel EM11, which can be used to store the images or documents or to call them again for further editing.

Arranged to the right of the image B1 below the menu panel EM11 is the input menu panel EM12, which presents control elements for the selection of a document of a photograph Ph1 for the purpose of further editing. By way of example, the image B1 is produced by the expert as a subsection of the photograph Ph1.

A further input menu panel EM13 is arranged below the image B1 and shows control elements for transmitting and storing completed images B1, B2, . . . . In this case, the images B1, B2, can be transmitted from the first control unit to the second control unit, for example. FIG. 3 shows the presentation of the images B1, B2, . . . which is visible to the maintenance engineer WT from his head-mounted display M2. The images B1, B2, . . . are each presented on the head-mounted display M1 at the same screen resolution as the images B1, B1, . . . on the first output unit M1.

Shown below the image B1 is the input menu panel EM2, which can be controlled by the maintenance engineer WT using the simple input means K. On the basis of his limited input means, the maintenance engineer selects the images, B2 . . . , through in the input menu panel EM2. Alternatively, the maintenance engineer can select the images sequentially merely using a “forward/back” key. The maintenance engineer is consciously severely restricted by the limited menu selection. As a result of the preselection and annotation of the images B1, B2, . . . by the expert in the back office, an intelligent preselection has been made, which means that the maintenance engineer WT can quickly and efficiently handle the current technical problem with a low error rate.

To the left of and below the first image B1, status information such as the customer name “xy” of the installation “A” is available to the maintenance engineer WT.

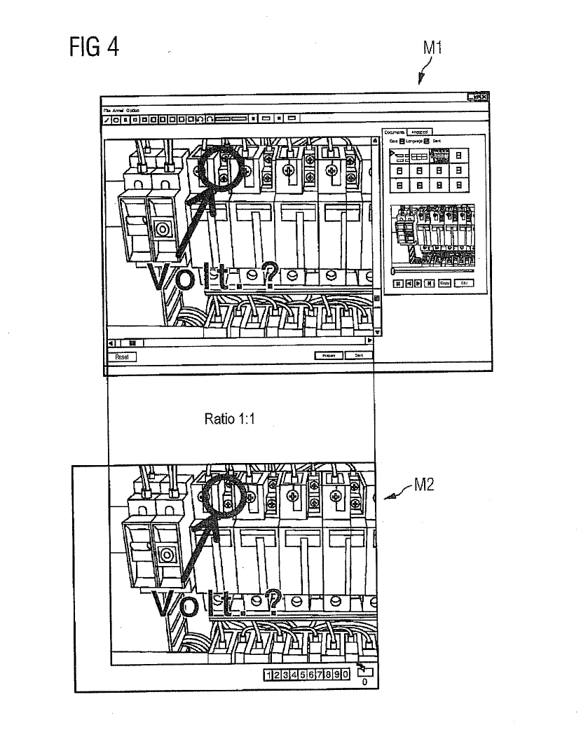

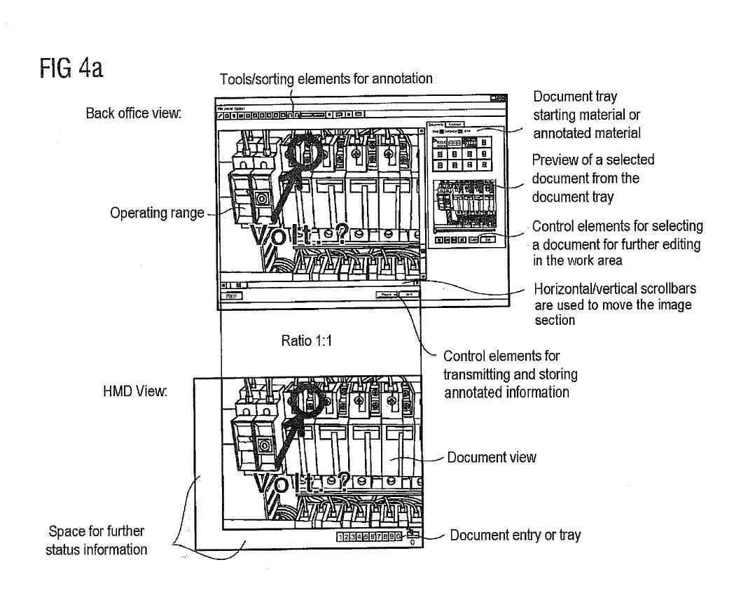

FIG. 4 compares the presentation of the image B1 on a first output unit M1 and the presentation of the image B1 on the second output unit M2. In this case, it can be seen that the maintenance engineer sees an image B1 which ahs the same resolution as the image B1 which the expert from a back office sees on his first output unit M1. In his work area, the expert on the first output unit M1 can see only the presentation which the maintenance engineer WT also sees. This prevents the maintenance engineer WT from seeing a poor resolution on his head-mounted display as a result of a lack of attention by the expert in the back office.

FIG. 4a shows a further embodiment of the image from FIG. 4, showing the input menus EMi from FIGS. 2 and 3 in detail.

1.-8. (canceled)

9. A method for transmitting a first image having a prescribed first image resolution from a first control unit having a first output unit to a second control unit having a second output unit, comprising:
providing the second output unit in a form of a head-mounted display; and
outputting the image on the second output unit at the prescribed first image resolution.

10. The method as claimed in claim 9, wherein the second control unit including the head-mounted display accesses the first image stored on the first control unit or a further image online via a data link.

11. The method as claimed in claim 9, wherein the second control unit including the head-mounted display accesses the first image stored on the first control unit or the further image by transmitting the first image or the further images via a data link to the second control unit, and are stored on the second control unit and output by the second control unit to the second output unit using an actuation of an input menu panel.

12. The method as claimed in claim 9,
wherein the second output unit holds, outside of the first image, further pixels for presenting status information and an input menu panel for sequentially calling the first image or a further image, and
wherein the further image is output on the second output unit at the same image resolution as on the first output unit.

13. The method as claimed in claim 9,
wherein the first image and/or the further image are formed from a subsection of a first or further digital photograph, which show a technical installation, and
wherein the respective subsection is overlaid with respective annotations for explaining the technical circumstances in the first or further photograph, for example text, freehand lines, circles, rectangles, etc.

14. The method as claimed in claim 9,
wherein the first output unit holds, outside of the first image or the further image, further pixels for presenting,
a first input menu panel for storing or transmitting the first or further image on/to the second control unit,
a second input menu panel for previewing and selecting a subsection of a photograph,
a third input menu panel for selecting a document including the first image and/or for selecting the photograph from a document tray, and
a fourth input menu panel for adding annotations to the photograph or to the first image.

15. The method as claimed in claim 9, wherein the first output unit includes a higher vertical and/or horizontal image resolution than the second output unit.

16. An output unit, comprising:
a control unit for carrying out a method for transmitting a first image having a prescribed first image resolution from a first control unit having a first output unit to a second control unit having a second output unit, the method comprising:
providing the second output unit in a form of a head-mounted display, and
outputting the image on the second output unit at the prescribed first image resolution.

17. The output device as claimed in claim 16, wherein the second control unit including the head-mounted display accesses the first image stored on the first control unit or a further image online via a data link.

18. The output device as claimed in claim 16, wherein the second control unit including the head-mounted display accesses the first image stored on the first control unit or the further image by transmitting the first image or the further images via a data link to the second control unit, and are stored on the second control unit and output by the second control unit to the second output unit using an actuation of an input menu panel.

19. The output device as claimed in claim 16,
wherein the second output unit holds, outside of the first image, further pixels for presenting status information and an input menu panel for sequentially calling the first image or a further image, and
wherein the further image is output on the second output unit at the same image resolution as on the first output unit.

20. The output device as claimed in claim 16,
wherein the first image and/or the further image are formed from a subsection of a first or further digital photograph, which show a technical installation, and
wherein the respective subsection is overlaid with respective annotations for explaining the technical circumstances in the first or further photograph, for example text, freehand lines, circles, rectangles, etc.

21. The output device as claimed in claim 16,
wherein the first output unit holds, outside of the first image or the further image, further pixels for presenting,
a first input menu panel for storing or transmitting the first or further image on/to the second control unit,
a second input menu panel for previewing and selecting a subsection of a photograph,
a third input menu panel for selecting a document including the first image and/or for selecting the photograph from a document tray, and
a fourth input menu panel for adding annotations to the photograph or to the first image.

22. The output device as claimed in claim 16, wherein the first output unit includes a higher vertical and/or horizontal image resolution than the second output unit.
